(19) United States
(12) Patent Application Publication
(10) Pub. No.: US 2016/0153945 A1
(43) Pub. Date: Jun. 2, 2016

(54) METHOD AND KIT FOR THE IDENTIFICATION OF COMPOUNDS IN AN ORGANIC MIXTURE

(71) Applicant: TOTAL S.A., Courbevoie (FR)

(72) Inventors: Daniel DESSORT, Doha (QA); Jacques BICKERT, Uzos (FR)

(73) Assignee: TOTAL S.A., Courbevoie (FR)

(21) Appl. No.: 14/905,489

(22) PCT Filed: Jul. 18, 2014
(86) PCT No.: PCT/EP2014/065540

§ 371 Date: Jan. 15, 2016

(30) Foreign Application Priority Data
Jul. 19, 2013 (FR) 1357113

(51) Int. Cl. G01N 30/86; G01N 30/14; G01N 30/72

(52) U.S. Cl. CPC G01N 30/86; G01N 30/7206; G01N 30/14; G01N 2030/025

(57) ABSTRACT

The present disclosure relates to a method for constituting a collection of chromatograms of a reference mixture of organic compounds. The present disclosure also relates to a method for the identification of compounds in a sample of an organic mixture using a collection of chromatograms. A kit is also provided for the identification of at least one compound in a sample from an organic mixture. The method and kit belong to the field of analytical chemistry.

### CROSS-REFERENCE TO RELATED APPLICATIONS

This application is a National Phase Entry of International Patent Application No. PCT/EP2014/065540, filed on Jul. 18, 2014, which claims priority to French Patent Application Serial No. 13 57 113, filed on Jul. 19, 2013, both of which are incorporated by reference herein.

### FIELD

The present invention relates to a method for constituting a collection of chromatograms of a reference mixture of organic compounds. The present invention also relates to a method for the identification of compounds in a sample of an organic mixture utilizing a collection of chromatograms. The present invention further relates to a kit for the identification of at least one compound in a sample from an organic mixture. The invention relates to the field of analytical chemistry.

### BACKGROUND AND SUMMARY

A mixture is an association of at least two, or more, substances that do not interact chemically with one another. These substances are closely juxtaposed in one and the same space to form a product. Each of these substances retains its physical and chemical properties.

A distinction is made between simple mixtures and complex mixtures. In a simple mixture, the constituents are easily identifiable as there are few of them. Moreover, each constituent has a chemical structure or a steric hindrance different from the other constituents of the mixture. For example, salt water is a simple mixture consisting of water and salt. In a complex mixture, the constituents are difficult to identify and/or separate as they are present in very large numbers (from about a hundred to several thousand). Moreover, these constituents may have similar chemical structures and similar physicochemical characteristics. Complex mixtures are for example crude oils (or petroleum) extracted from geological formations, gasolines or solvents originating from refining operations, a perfume or a plant extract, contaminated rainwater, wine, etc.

The remainder of the present description relates to homogeneous complex mixtures, i.e. those having just one phase, either liquid or gaseous. Complex mixtures are analysed by separation techniques generally coupled to identification techniques. The separation technique most commonly used is chromatography, in particular liquid chromatography or gas chromatography. With this technique it is possible to separate the constituents of a mixture by the joint use of two mutually immiscible phases, one of the phases of which is in motion, and in which the solutes to be separated are distributed differentially.

However, the identification of the constituents of a complex mixture by chromatography is not always successful, even when a chromatography column is coupled to sophisticated detectors, such as for example a mass spectrometer or an atomic emission spectrometer. The chromatograms obtained are analysed by a specialist in chromatographic techniques. This specialist carries out a visual identification of the various chromatographic peaks. He makes a judgment about the presence or absence of the compound to be identified from the location, measurement of the area and/or height of the chromatographic peak, which is a function of the quantity of the product that it represents. The drawback of this method is that it is very empirical, subjective, of low productivity, and has to be carried out by a specialist.

Another technique of chromatographic analysis that may be used for studying the constituents of a complex mixture consists of an automatic identification of the constituents from their retention time generally visualized with, for example, a UV (ultraviolet) spectrometer in liquid chromatography or using a flame ionization detector in gas chromatography. These techniques require calibration of the apparatus with internal or external standard compounds. The drawback of this method is that it is valid for a limited length of time, i.e. for as long as the ageing of the column is not too marked. In fact, as the chromatography column ages, this leads to a slow drift of the initial chromatographic characteristics, such as a change of the baseline, change of the retention times of the products, etc. Identification of the constituents of a mixture becomes difficult despite the calibrations that have been carried out. Another drawback of this method is the large number of calibrations required to take into account the ageing of the column. These time-consuming calibrations are expensive since they require the use of standard compounds and supervision by a specialist.

The aforementioned method has been improved by using retention indices for the identification of the compounds automatically. This method requires the use of two reference compounds: generally a compound having a lower retention time (compound A) than the retention time of the compounds to be analysed, and another having a higher retention time (compound D) than the retention times of the compounds of interest. The relative retention time (or retention index) of a compound (compound B) corresponds to the ratio of the difference in the retention time of compound B and the retention time of compound A on the one hand, and the difference between the retention time of compound D and the retention time of compound A on the other hand. Compounds A and D are two compounds that are known and are easily identifiable on a chromatogram and are therefore taken as a reference. This method of retention indices is more accurate than the method of retention times. However, it does not limit the number of calibrations, nor supervision and validation of the results by a specialist. In fact, the retention indices are themselves subject to fluctuations with ageing of the chromatographic column.

Coupling chromatographic techniques with spectrometric methods of identification has provided progress relative to the previous methods. In fact, a compound is identified both from the chromatographic data by analysing the retention times or retention indices, and from the spectroscopic characteristics of the compounds. However, although these techniques are becoming more and more accurate, numerous constituents may have identical spectroscopic characteristics, leading to confusion in identifying the constituents of a complex mixture.

Therefore, there is still a need for a method for the identification of constituents of a mixture, the implementation of which is simple and inexpensive, and that allows the constituents of a mixture to be identified with great reliability. In particular, there is still a need for a method that allows this identification to be carried out regardless of the degree of ageing of the chromatography column. There is also a need for a method for the identification of constituents of a mixture, the analysis of the results of which is independent of the operator which carries out this method.

The purpose of the present invention is to provide a method for the identification of at least one compound in an organic mixture using at least one step of separation by a chromatography column, at least partially overcoming the aforementioned drawbacks. More particularly, the present invention relates to a method for constituting a collection of chromatograms of a reference mixture, the chromatograms being periodically recorded during the lifetime of a chromatographic column, during the learning period. The present invention also relates to a method for the identification of at least one compound in a sample from an organic mixture by comparing the chromatogram of the sample from the mixture to be analysed with those of the collection of chromatograms constituted previously. Finally, the invention relates to a kit for implementing the above methods.

The present invention advantageously makes it possible to limit or even eliminate the number of calibrations that must be carried out before each chromatographic analysis. The present invention also makes it possible to increase the reliability of identification of the compounds in a mixture. Validation of the results by a specialist is no longer absolutely necessary when implementing the invention. Finally, the present invention can easily be adapted to all kinds of organic mixtures. Advantageously, the present invention can be adapted to any chromatographic technique of column separation. The method for the identification of compounds in an organic mixture according to the invention has the advantage that it can be automated.

To this end, the present invention relates to a method for constituting a collection of data from chromatograms of a reference mixture R1 of organic compounds comprising at least two markers M and for at least one chromatographic device comprising at least one chromatographic column and at least one detection means measuring a physical quantity, said method comprising the following steps:
(a) constituting a mixture R2 comprising at least two probes S, each probe S being characterized by an unequivocal signal detectable at a specific value VS_{probe} of the physical quantity measured;
(b) at a time t₀, simultaneously introducing the mixtures R1 and R2 into the chromatography column coupled to the detection means,
(c) eluting the markers M and the probes S with at least one mobile phase,
(d) recording the elution chromatogram of the mixture R1 and R2,
(e) identifying the retention time of each of the probes S on the chromatogram from step d) so as to obtain a fingerprint E₀,
(f) identifying the retention time of each of the markers M on the elution chromatogram from step d),
(g) obtaining the chromatogram C₀ associated with the fingerprint E₀,
(h) repeating steps b) to g) at regular intervals t₁, t₂ . . . tᵢ . . . tₙ during the lifetime of the column so as to constitute a collection of chromatograms C₀, C₁, C₂ . . . Cᵢ . . . Cₙ, associated with a fingerprint E₀, E₁, E₂ . . . Eᵢ . . . Eₙ respectively for each time tᵢ with i varying from 0 to n, n being an integer n>0.

According to preferred embodiments, the invention comprises one or more of the following characteristics, taken alone or in combination:
the probe S is a probe labelled with at least one marker group selected from the group formed by a chromophore that absorbs in the ultraviolet, a chromophore that absorbs in the infrared, a phosphor or a stable isotope;
the chromatography column is selected from the group comprising an adsorption column, a partition column, an affinity column, an ion exchange column or a size exclusion column, preferably a partition column;
the physical quantity measured is selected from a wavelength, a mass/charge ratio m/z, an intensity, a strain, a chemical shift;
the physical quantity measured is a mass/charge ratio m/z and the detection means is a mass spectrometer;
said recording of the chromatogram in step (d) is carried out by recording all of the spectrograms of the mass/charge ratios or by recording certain spectrograms at defined mass/charge ratios.

The present invention also relates to a collection of chromatograms C₀, C₁, C₂ . . . Cᵢ . . . Cₙ resulting from:

simultaneous elution, repeated at times t₀, t₁ t₂, . . . tᵢ . . . tₙ, n being an integer n>0, of a reference mixture R1 of organic compounds comprising at least two markers M and of a mixture R2 comprising at least two labelled probes S, on a chromatography column, and detection of the components of the mixture R1+R2 using at least one detection means measuring at least one physical quantity, each probe S being characterized by at least one unequivocal signal detectable at a specific value VS_{probe} of the physical quantity measured, and

recording the elution chromatogram of the markers, each chromatogram C_{i with 0≦i≦n} comprising a fingerprint E_{i with 0≦i≦n} corresponding to the retention times of the probes of the mixture R2.

The present invention also relates to a method for the identification of at least one compound in a sample from an organic mixture, the method comprising the following steps:

(a1) providing a chromatographic device comprising at least one chromatographic column and at least one detection means measuring a physical quantity, said detection means being coupled to the chromatographic column,

(b1) providing at least one collection of chromatograms of a reference mixture R1 and of a mixture R2 of probes S defined above or obtained by implementing the method as described above using a chromatographic column and a detection means identical to those utilized in step (a1),

(c1) simultaneously introducing, into the chromatographic device, the sample and the mixture R2 that is identical to the mixture R2 that was used for constituting the collection of chromatograms,

(d1) eluting the compounds of the sample and the probes S with at least one mobile phase,

(e1) recording the elution chromatogram C of the probes S and of the compounds in the sample,

(f1) identifying the retention time of each probe S of the mixture R2 on the chromatogram C obtained in step (e1) in order to obtain the fingerprint E of the sample,

(g1) comparing the fingerprint E from step (f1) with each fingerprint E₀, E₁, E₂ . . . Eᵢ . . . Eₙ of the chromatograms C₀, C₁, C₂ . . . Cᵢ . . . Cₙ of the collection of chromatograms,

(h1) identifying the chromatogram Cⱼ of which the fingerprint Eⱼ is substantially superposable on the fingerprint E from step (g1),

(i1) comparing chromatogram C with chromatogram Cⱼ.

According to preferred embodiments, the invention comprises one or more of the following characteristics, taken alone or in combination:
the organic mixture is a crude oil;
the reference mixture R1 comprises at least two markers M selected from the group comprising saturated or unsaturated, linear or branched hydrocarbons comprising from 5 to 50 carbon atoms, cyclic hydrocarbons, in particular aromatic hydrocarbons, comprising from 5 to 50 carbon atoms and mixtures thereof;
the mixture R2 comprises at least two deuterium-labelled probes S, each probe S being a hydrocarbon compound comprising at least 5 carbon atoms, preferably from 5 to 50 carbon atoms, said compound being saturated, unsaturated, linear, branched or cyclic, in particular aromatic, and optionally comprising at least one sulphur, oxygen or nitrogen heteroatom;
steps (g1) and (i1) are carried out using information technology means, preferably software.

The present invention makes it possible to overcome the drawbacks of the methods of the prior art. Advantageously, it provides a method that is simple, rapid, reliable and inexpensive for the analysis and identification of one or more compounds in an organic mixture, in particular a complex organic mixture. The invention makes it possible to eliminate the steps of standardization and/or calibration that have to be carried out when using a chromatographic column.

Advantageously, the present invention may be used on chromatography devices operating with a column having a stationary phase of the same nature as that used for constituting the collection of reference chromatograms without having to establish a collection of chromatograms again whenever the device is changed. Thus, the collection of data according to the invention is representative of the ageing of a stationary phase for a given mixture and for a given type of stationary phase, under similar operating conditions (mobile phase, pressure, temperature, flow rate etc.). Moreover, the invention can be utilized for any organic mixture, regardless of the chemical nature of the mixture. It can be utilized advantageously for any type of stationary phase used in a chromatography column.

Furthermore, the present invention improves the reliability of the results of a chromatographic analysis of a complex organic mixture. Analysis of the compounds is carried out by the automated comparison of chromatograms against a collection of chromatograms obtained from a reference organic mixture. The intervention of a specialist for analysis of the chromatograms is no longer obligatory. Advantageously, the present invention can be automated, making completely autonomous analysis of complex mixtures possible.

The present invention also relates to a kit for carrying out the methods described above, said kit comprising at least:
a reference mixture R1 comprising at least two markers M selected from the group comprising saturated or unsaturated, linear or branched hydrocarbons comprising from 5 to 50 carbon atoms, cyclic hydrocarbons, in particular aromatic hydrocarbons comprising from 5 to 50 carbon atoms, steroids and mixtures thereof,
a mixture R2 comprising at least two deuterium-labelled probes S, each S being a hydrocarbon compound comprising at least 5 carbon atoms, preferably from 5 to 50 carbon atoms, said compound being saturated, unsaturated, linear, branched, and/or cyclic, in particular aromatic, and optionally comprising at least one sulphur, oxygen or nitrogen heteroatom.
   According to a preferred embodiment, the kit may further comprise a chromatography column.

The present invention also relates to a kit for carrying out the method for the identification of at least one compound in a sample from an organic mixture as described above, said kit comprising:
a collection of chromatograms as described above,
a chromatography column identical to that used for constituting the collection of chromatograms,
a mixture of probes R2 identical to that used for obtaining the collection of chromatograms.

### BRIEF DESCRIPTION OF THE DRAWINGS

Other features and advantages of the invention will become clearer on reading the following description and a particular embodiment given purely by way of illustrative and non-limitative example, and the attached drawings, in which:

FIG. 1 shows the main steps of the method for constituting a collection of chromatograms according to the invention;

FIG. 2 shows the main steps of the method for the identification of at least one compound in a sample from an organic mixture according to the invention;

FIG. 3 shows a chromatogram and signals obtained by implementing out the methods according to the invention;

FIG. 4 shows a chromatogram C₀ obtained by implementing the methods according to the invention;

FIG. 5 shows an example of a spectrogram of the signals from the probes utilized in the method according to the invention; and

FIG. 6 shows an example of a spectrogram of the signals from the markers utilized in the method according to the invention.

### DETAILED DESCRIPTION

The invention relates to the field of analytical chemistry. The purpose of the present invention is to provide:
a method for constituting a collection of chromatograms for a reference organic mixture, and
a method for the identification of at least one compound in a sample from an organic mixture by chromatography, said methods overcoming the drawbacks of the prior art.

By “organic mixture” is meant, within the meaning of the present invention, any mixture comprising at least two organic compounds of natural or synthetic origin. Preferably, these compounds are non-polymeric organic molecules. By “polymeric organic molecules” is meant the molecules that result from the polymerization of a monomer to form a polymer such as, for example, proteins, DNA or RNA. The organic compounds forming the organic mixture according to the invention have a molecular weight less than or equal to 1000 dalton, preferably a molecular weight ranging from 16 to 1000 dalton. Preferably, the organic mixture is a complex organic mixture. By “complex organic mixture” or “complex mixture” is meant, within the meaning of the present invention, a mixture of which the components are present in very large numbers and have similar chemical structures and similar physicochemical characteristics. By way of a non-limitative example, complex organic mixtures may comprise aromatic or non-aromatic hydrocarbons, such as polycyclic aromatic hydrocarbons (PAH), hydrocarbons extracted from a geological formation, molecules of synthetic origin (cosmetic or therapeutic active ingredients), extracts from plants or from animals, metabolites, etc. By way of a non-limitative example, complex organic mixtures within the meaning of the present application may be:
a blood sample for testing for the presence of a medicinal product, a toxin, an illegal substance, or a metabolite in the blood;
a sample of water obtained from a marine environment, a lake, a river or a water table;
a sample of sediments;
a sample of a gaseous atmosphere or originating from sampling in a gaseous atmosphere,
a sample of a food, pharmaceutical or cosmetic product;
a sample of crude oil or any sub-fraction of crude oil. By “crude oil” is meant hydrocarbons sampled at the surface (of the ground or of a sheet of water), extracts from a geological formation, such as for example petroleum, bituminous oils, shale gases or oils, etc. By “sub-fraction of crude oil” is meant, within the meaning of the present invention, a crude oil that has undergone a chemical or physical treatment in order to isolate a subset of its constituents. The techniques making it possible to obtain a fraction of a crude oil are well known to a person skilled in the art. These techniques are generally implemented by liquid chromatography. For example, a sub-fraction of a crude oil may consist of all of the aromatic or saturated compounds of the crude oil.

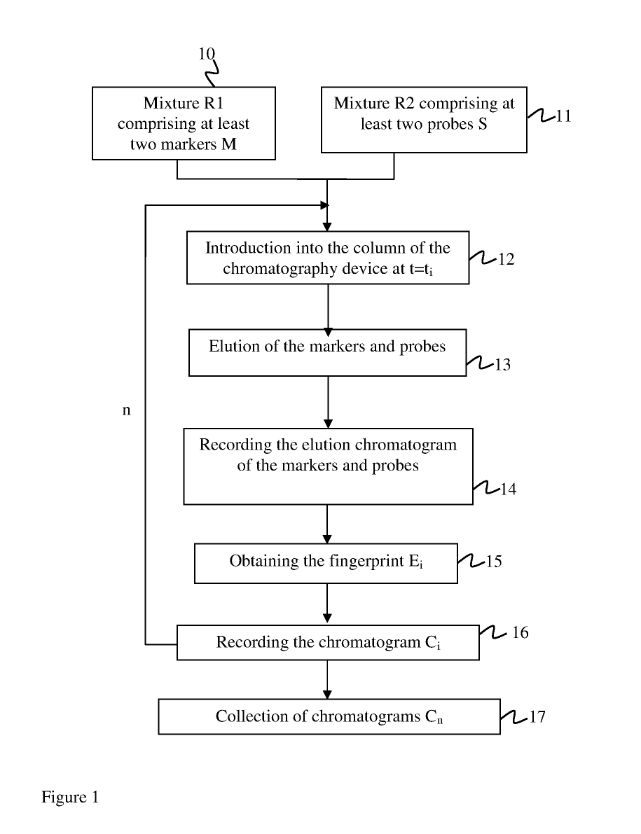

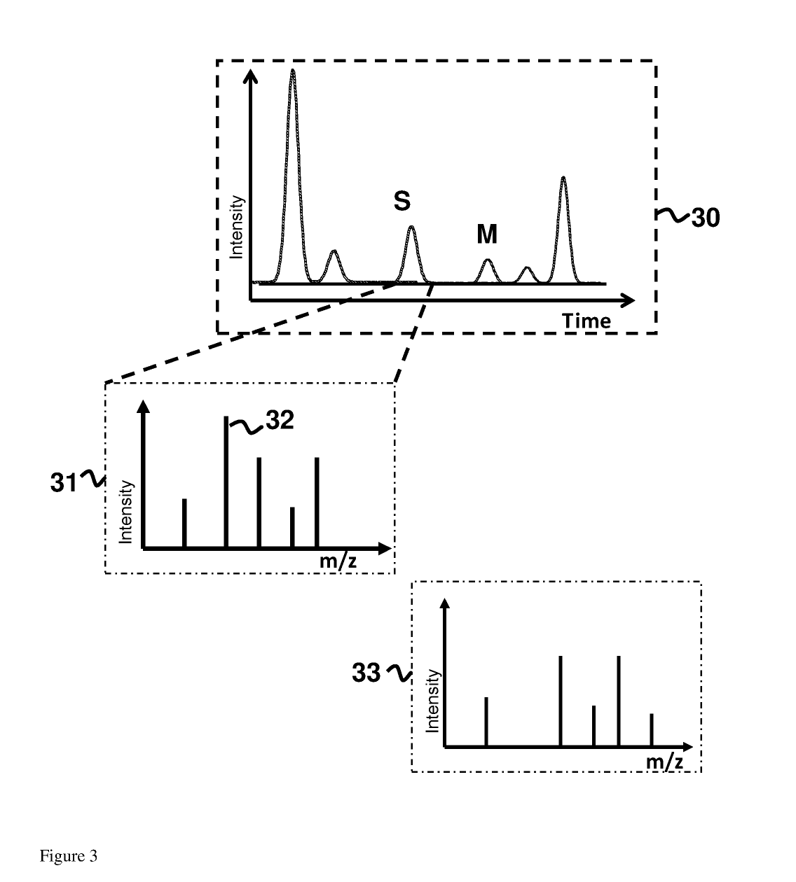

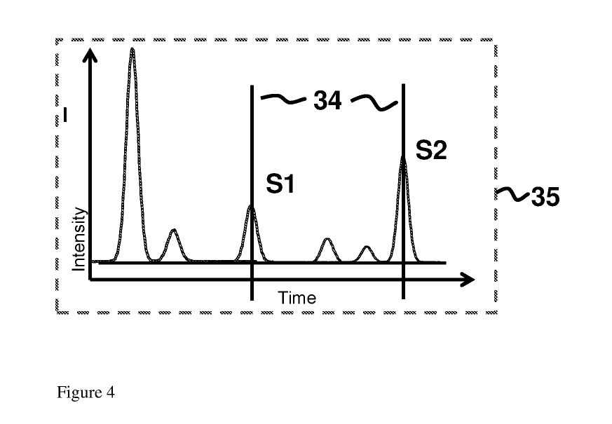

A first subject of the present invention relates to a method for constituting a collection of chromatograms for a reference mixture R1 of organic compounds comprising at least two markers M and for at least one chromatographic device comprising at least one chromatographic column and at least one detection means measuring a physical quantity, said method comprising the following steps:
(a) constituting a mixture R2 comprising at least two probes S, each probe S being characterized by an unequivocal signal detectable at a specific value VS_{probe} of the physical quantity measured;
(b) at a time t₀, simultaneously introducing the mixtures R1 and R2 into the chromatography column coupled to the detection means,
(c) eluting the markers M and the probes S with at least one mobile phase,
(d) recording the elution chromatogram of the mixture R1 and R2,
(e) identifying the retention time of each of the probes S on the chromatogram from step d) so as to obtain a fingerprint E₀,
(f) identifying the retention time of each of the markers M on the elution chromatogram from step d),
(g) obtaining the chromatogram C₀ associated with the fingerprint E₀,
(h) repeating steps b) to g) at regular intervals t₁ m t₂ . . . tᵢ . . . tₙ during the lifetime of the column so as to constitute a collection of chromatograms C₀, C₁, C₂ . . . Cᵢ . . . Cₙ, associated with a fingerprint E₀, E₁, E₂ . . . Eᵢ . . . Eₙ respectively for each time tᵢ with i varying from 0 to n, n being an integer n>0.
   The main steps of the method for constituting a collection of chromatograms for a reference mixture R1 of organic compounds are now presented, with reference to FIG. 1, FIG. 3 and FIG. 4.

Constitution (10) of the Reference Mixture R1

By “marker” is meant, within the meaning of the present invention, a compound or a set of compounds that makes it possible to identify characteristics of a mixture. A complex mixture may comprise compounds that are specific to a geographic origin of a mixture, the age of a mixture, a method of manufacture of a mixture, etc. These compounds form the chemical signature of a complex mixture and are used in the present invention as markers M.

The marker or markers M are compounds selected so as to be representative of the type of organic mixture that one wishes to analyse. The markers may be compounds of a mixture that are found randomly in abundance in the mixture or on the contrary are rarely found in a mixture. By “reference mixture” is meant, within the meaning of the present invention, a set of markers as defined above, forming an artificial signature of the mixture to be investigated.

In an embodiment, the reference mixture R1 may comprise all of the chemical signatures known for an organic mixture to be investigated. In another embodiment, the reference mixture R1 comprises at least two markers M as defined above. The number and the variety of the markers making up the reference mixture are adapted as a function of the complexity of the samples that must then be investigated.

In an embodiment of the invention, when the sample is a crude oil or a sample of a sub-fraction of a crude oil, a mixture comprising at least two markers, in particular at least two biomarkers, is used as the reference mixture R1. A crude oil is a complex mixture that may contain thousands of different hydrocarbons, all in variable concentrations. The geological origin, chemical composition or age of a crude oil may be identified by the chemical nature of some of its hydrocarbons. Certain hydrocarbons are specific to a given type of deposition environment of the mother rock, its geological age and the chemical, microbiological, physical and thermal changes that have affected the hydrocarbons during their history. These particular compounds that make it possible to characterize the origin of a crude oil are called biomarkers.

Advantageously, the markers M, in particular the biomarkers, may be selected from saturated or unsaturated, linear or branched hydrocarbons comprising from 5 to 100 carbon atoms. Advantageously, the markers M, in particular the biomarkers, may be selected from linear or branched saturated hydrocarbons comprising from 5 to 100 carbon atoms such as n-, iso- and methyl-alkanes, isoprenoids, diterpenoids, polyprenoids and mixtures thereof. Advantageously, the markers M, in particular the biomarkers, may be selected from the cyclic hydrocarbons, in particular aromatic, comprising from 5 to 100 carbon atoms, such as
tri-, tetra-, penta- and hexacyclic triterpanes, such as oleanane, hopanes and methyl-hopanes, bisnorhopanes, 25-norhopanes, 8,14-secohopanes,
steranes such as regular steranes, rearranged steranes, methyl-steranes and iso-steranes, cholestane, diasteranes. These categories generally differ from one another by the stereochemical configuration of certain atoms or groups of atoms,
terpanes such as gammacerane,
mono- and bicyclanes,
and mixtures thereof.

Advantageously, the markers M, in particular the biomarkers, may be selected from the aromatic hydrocarbons not containing sulphur, such as benzene, toluene, xylene, naphthalene, phenanthrene, anthracene, chrysene (including the isomers and the compounds derived from these basic structures by the addition of groups of atoms such as an alkyl chain, methyl groups), benzohopanes, 8,14-secohopanoids and mixtures thereof. Advantageously, the markers M, in particular the biomarkers, may be selected from the sulphur-containing aromatic hydrocarbons such as thiolane, thiane, thiophene, benzothiophene, dibenzothiophene, naphthobenzothiophene (including the isomers and the compounds derived from these basic structures by the addition of groups of atoms such as an alkyl chain, methyl groups) and mixtures thereof. Advantageously, the markers M, in particular the biomarkers, may be selected from regular steroids, rearranged steroids and iso-steroids; mono- and tri-aromatic methyl-steroids and mixtures thereof. Each of these categories generally differ from one another by the stereochemical configuration of certain atoms or groups of atoms. Advantageously, the markers M, in particular the biomarkers, may be selected from saturated or unsaturated, linear or branched hydrocarbons, cyclic hydrocarbons, in particular aromatic hydrocarbons, steroids as described above and mixtures thereof. Advantageously, when the sample is a crude oil or a sample of a sub-fraction of a crude oil, the reference mixture R1 comprises at least one marker selected from the n-, iso- and methyl-alkanes comprising from 5 to 100 carbon atoms, at least one marker selected from the family of the hopanes, at least one marker selected from the tri-, tetra-, penta- and hexacyclic triterpanes, the gammacerane marker, the oleanane marker, at least one marker selected from the diahopanes, at least one marker selected from the regular steranes, at least one marker selected from the 8,14-secohopanes, at least one marker selected from the diasteranes.

Chromatographic Device

The chromatographic device according to the invention comprises at least one chromatography column and at least one detection means measuring a physical quantity, said detection means being coupled to the chromatography column. By “chromatography column” or “chromatographic column” or “column” is meant, within the meaning of the present invention, a narrow tube comprising a stationary phase, through which at least one mobile phase can pass, which moves by gravity or by difference of pressure.

The invention can be implemented with any stationary phase that may be altered by prolonged use and that may potentially interact with the products injected. The ageing of the stationary phase generally induces a drift of the baseline and a drift of the retention times and indices of the products eluted. These drifts are signs of ageing or of wear of the stationary phase, and therefore of the chromatographic column.

The choice of the type of column, the mobile phase, the stationary phase and the operating conditions of the chromatography column and of the detection means depends on the nature of the reference mixture R1 or the nature of the sample of the organic mixture to be analysed. These choices and optimization of the operating conditions are steps that are well known to a person skilled in the art. Therefore, the implementation of the method according to the invention is not limited to a particular type of stationary phase or to a particular mobile phase.

Advantageously, the column is adapted for use in gas-liquid chromatography or for use in gas chromatography. Advantageously, the separation of the constituents of the mixture may be carried out by an adsorption column, a partition column, an affinity column, an ion exchange column, a size exclusion column or a capillary electrophoresis column. Preferably, when the stationary phase is solid, the column is an adsorption, affinity, ion exchange or exclusion column. Advantageously, the column is a partition column.

The stationary phase may be liquid or solid. Its state depends not only on the nature of the product constituting the stationary phase, but also the conditions of pressure and temperature in which the method of the invention is implemented. The stationary phase may or may not be grafted chemically to the tube of the column. Advantageously, among the liquid stationary phases, polar or nonpolar phases generally consitituting of silicones or of fluorinated polymers can be selected. Advantageously, among the solid stationary phases, porous polymers, liquid crystals, dextrins, alumina, activated charcoal and hydrocarbons (for example: squalane, heavy n-alkanes) can be selected.

The mobile phase is a fluid selected from liquids or gases. Among the liquid mobile phases, pure solvents or a mixture of solvents can be mentioned. Among the gaseous mobile phases, hydrogen, helium, nitrogen, argon or a mixture of these gases can be mentioned.

The implementation conditions of the chromatography device are selected to allow satisfactory resolution of the compounds of the reference mixture and of the mixture of the probes. Usually one tries to optimize these conditions so that each compound is eluted individually, preferably with return to the baseline of the elution chromatogram between each peak.

In an embodiment of the invention, when the sample is a crude oil, in particular a sample of a sub-fraction of this crude oil, the chromatographic column is adapted for use in gas chromatography; in particular the stationary phase is selected from the nonpolar phases and the mobile phase is selected from helium, nitrogen, argon or hydrogen. The chromatography device utilized in the context of the present invention comprises at least one detection means measuring a physical quantity, said detection means being coupled to the outlet of the chromatographic column.

The detection means comprises at least one detector and at least one recorder, in particular a computer. The recorder supplies a trace of the signals recorded, said trace comprising the chromatographic peaks, and each peak may correspond to one or more compound(s) eluted. The detection means coupled to the chromatography column therefore allows an elution chromatogram (30) to be obtained. The detector makes it possible to detect at least one signal for a physical quantity that is being measured.

The physical quantity being measured may be a wavelength, a mass/charge ratio (m/z), an intensity, a strain, a resistance, a chemical shift, etc. Advantageously, the physical quantity measured is a mass/charge ratio (m/z).

The detector may be selected from detectors recording simple signals or complex signals. By “simple signal” is meant a single signal for a given molecule that is recorded for a measured physical quantity. The detection means records a single chromatogram and the detection is called simple detection. By “complex signal” is meant a plurality of signals for a given molecule that are recorded simultaneously for a measured physical quantity. The detection means records several chromatograms (one for each physical quantity of the range) and the detection is called complex detection.

For example, among the detection means recording simple signals, there can be mentioned:
flame ionization detectors (FID),
thermal conductivity detectors (TCD),
electron capture detectors (ECD),
oxygen detectors (O-FID),
catalytic combustion detectors (CCD),
sulphur detectors (FPD, SCD and P-FPD),
nitrogen or phosphorus detectors (NPD), photo-ionization detectors (PID),
thermal ionization detectors (TID),
nano-electromechanical system (NEMS) detectors,
refractometry detectors, light scattering detectors,
UV-Visible absorption detectors,
fluorescence detectors,
electrochemical detectors.

Among the detection means recording complex signals, there can be mentioned:
spectrometers in the wavelength range of the UV, visible or infrared (IR) spectrum,
mass spectrometers, whatever their principle,
atomic emission spectrometry detectors (ICP: Induced Coupled Plasma),
infrared spectrometry detectors (FTIR: Fourier transform infrared), or nuclear magnetic resonance (NMR) detectors,
spectrometers in the wavelengths of the UV or visible spectrum,
fluorescence spectrometers,
nuclear magnetic resonance (NMR) detectors.
   The detection means supplying complex signals are also capable of recording simple signals.

The choice of detection means depends on the nature of the sample to be investigated, as a function of the nature of the mobile phase utilized in the chromatography device and as a function of the type of probe S and its optional labelling. Preferably, when the mobile phase is liquid, the detection means is selected from the group formed by refractometers, UV-Visible absorption detectors, infrared absorption detectors, fluorescence spectrometers, light scattering detectors, diode array detectors, electrochemical detectors, differential refractometers, nuclear magnetic resonance (NMR) detectors or mass spectrometers (MS). Advantageously, the detection means is a mass spectrometer. Preferably, when the mobile phase is gaseous, the detection means is selected from the group formed by flame ionization detectors (FID), thermal conductivity detectors (TCD), catalytic combustion detectors (CCD), infrared spectrometers (FTIR: Fourier transform infrared), atomic emission spectrometers (AED, ICP), electron capture detectors (ECD), oxygen detectors (O-FID), catalytic combustion detectors (CCD), nano-electromechanical system (NEMS) detectors, sulphur detectors (FPD, SCD and P-FPD), nitrogen or phosphorus detectors (NPD), photo-ionization detectors (PID), mass spectrometers (MS), photo-ionization detectors (PID) or thermal ionization detectors (TID). Advantageously, the detection means is a mass spectrometer.

Advantageously, when the mobile phase is gaseous and the sample to be investigated is a crude oil, in particular a sample of a sub-fraction of this crude oil, the detection means is a mass spectrometer. Among the mass spectrometers that may be utilized in the context of the invention, quadrupole mass spectrometers, magnetic or electrostatic sector mass spectrometers, time-of-flight mass spectrometers, ion trap or Fourier transformation mass spectrometers can be mentioned, non-limitatively. The ionization mode may be by electron bombardment, by chemical ionization, by laser radiation, by bombardment with fast or metastable atoms, by photoionization or by field ionization. Of course, the chromatographic device used in the context of the present invention further comprises means for injecting a sample into the column, means for introducing the mobile phase into the column, means for controlling the operating parameters, coupling means between the column and the detection means and any other means necessary for the operation of such a device.

Constitution (11) of the Mixture R2

The mixture R2 comprises at least two probes S. By “probe” is meant, in the present invention, a molecule representative of at least one chemical family of a marker M and characterized by at least one unequivocal signal (32) with respect to the signals corresponding to the compounds making up the mixtures R1 and R2, the unequivocal signal being detectable at a specific value VS_{probe} of the physical quantity measured. An unequivocal signal (32) is a signal that makes it possible to identify, clearly and without ambiguity, the probe S with respect to the compounds of the mixture R1 and R2.

The unequivocal signal (32) is easily identifiable as it is detectable at a specific value VS_{probe} of the physical quantity measured. The value VS_{probe} is the value of the physical quantity measured by the detector at which only the probe emits an unequivocal signal. This value VS_{probe} therefore makes it possible to record only the signal from the probe.

For example, an unequivocal signal from a probe S may be a single infrared absorption line specific of the probe S, which is not found on the infrared spectra of the markers M. In this case, the specific value VS_{probe} is the value of the wavelength at which the infrared absorption line is observed.

In another example, an unequivocal signal (32) from a probe S may be an ion-fragment obtained for a given mass/charge ratio (m/z) (31) when the probe is ionized and fragmented. This ion-fragment is specific to the probe. When the markers M are ionized and fragmented, the ion-fragments of the markers have values of the mass/charge ratio (m/z) that are different from those of the probes (33). The specific value VS_{probe} is, in this case, the value of the mass/charge ratio (m/z) at which the ion-fragment specific to the probe is observed.

Thus, each probe S according to the invention is easily identifiable, since it is eluted in the form of a peak that is identifiable owing to the unequivocal signal (32) recorded by the detection means at a specific value VS_{probe} of the physical quantity measured. For example, cholestane-d4 gives a specific mass/charge m/z signal 221 when a mass spectrometer is used as the detector.

In an embodiment of the invention, the probe S is a probe labelled with a marker group. The labelling of the probe S with a marker group allows to facilitate production of the unequivocal signal. The marker group may be an isotope, a chromophore that absorbs ultraviolet (UV), a chromophore that absorbs infrared (IR) or a phosphor. The isotope is generally selected from the stable isotopes, such as deuterium (²H), carbon 13 (¹³C), oxygen 18 (¹⁸O), sulphur (³⁴S), nitrogen 15 (¹⁵N). A phosphor is a molecule or a chemical group capable of emitting light at a given wavelength when this molecule or this chemical group is excited. Labelling of the probe is a technique well known to a person skilled in the art. It consists either of grafting the marker group (for example chemical grafting of a chromophore) onto the probe, or of synthesizing a probe in which the marker group is incorporated in the probe during synthesis (for example incorporation of one or more isotopes during chemical synthesis of the probe).

Preferably, the probe according to the invention is labelled with deuterium and is selected so as to provide an unequivocal signal that is detectable at a specific value VS_{probe} of the physical quantity measured. The use of deuterium-labelled compounds in gas chromatography offers many advantages. These compounds do not display the same steric hindrance as the unlabelled compounds. They therefore have shorter retention times than their protonated homologues, which greatly limits the interference on the chromatogram. A deuterium-labelled probe is easily identifiable by mass spectrometry owing to its unequivocal signal and its retention time, which differ from those of a probe comprising protons.

In an embodiment of the invention, the specific value VS_{probe} is different for each probe S of the mixture R2. In another embodiment of the invention, the specific value VS_{probe} is the same for at least two probes of the mixture, these probes being differentiated from one another by their retention times. Thus, the chromatographic peaks of the probes are distributed along the chromatogram.

Preferably, when the sample to be investigated is a crude oil, in particular a sample of a sub-fraction of this crude oil, the probes S are hydrocarbon compounds comprising at least 5 carbon atoms, preferably from 5 to 50 carbon atoms, said compounds being saturated or unsaturated, linear, branched or cyclic, in particular aromatic, and optionally comprising at least one sulphur, oxygen or nitrogen heteroatom. Advantageously, the probes S are labelled with at least one stable isotope selected from deuterium (²H), carbon 13 (¹³C), oxygen 18 (¹⁸O), sulphur (³⁴S), nitrogen 15 (¹⁵N), preferably deuterium. Advantageously, the probes S are selected from the group formed by saturated or unsaturated, linear or branched hydrocarbons comprising from 5 to 50 carbon atoms optionally labelled with deuterium, cyclic hydrocarbons optionally labelled with deuterium comprising from 5 to 50 carbon atoms, aromatic hydrocarbons optionally labelled with deuterium comprising from 5 to 50 carbon atoms, steroids optionally labelled with deuterium and mixtures thereof.

Among the deuterium-labelled linear or branched saturated hydrocarbons, n-alkanes comprising from 5 to 50 carbon atoms and 1 to 102 deuterium atoms, in particular an alkane comprising 24 carbon atoms and 50 deuterium atoms (nC24-d50), an alkane comprising 36 carbon atoms and 74 deuterium atoms (nC36-d74) can be mentioned. Among the deuterium-labelled cyclic hydrocarbons, cholestane-d₄ can be mentioned. Among the deuterium-labelled unsaturated hydrocarbons, cholestene-d4 can be mentioned. Among the deuterium-labelled sulphur or not sulphur aromatic hydrocarbons, naphthalene-d₈, phenanthrene-d₁₀, dibenzothiophene-d₈ and chrysene-d₁₄ can be mentioned.

Introduction (12) into a Column and Elution (13) of the Markers and Probes

The mixtures R1 and R2 are introduced simultaneously by introduction means that are well known to a person skilled in the art, such as a syringe, an injection valve, etc. Prior to their introduction into the chromatography device, the mixture R1 and/or the mixture R2 may undergo at least one step of preparation such as filtration, dilution in a solvent, etc. The compounds of the markers M and of the probes S are eluted by the mobile phase in the chromatography column. The means for introducing the mobile phase are well known to a person skilled in the art.

Elution Chromatogram (14)

The chromatogram (14) is recorded, which comprises:

the chromatographic peaks of each probe and the unequivocal signal from the probe associated with each of these peaks, and

the chromatographic peaks of each marker and the signal or the signals of the markers associated with each of these peaks.

The peaks and the signals of the probes are recorded at least at a specific value VS_{probe} of the physical quantity measured. The peaks and the signals of the markers are recorded at at least one value of the physical quantity measured (VSₘₐᵣₖₑᵣₛ), this value being different from the specific value VS_{probe}. The value of the measured physical quantity at which the signals of the markers VSₘₐᵣₖₑᵣₛ are detected may be fixed or may vary over a given range of the physical quantity measured.

In an embodiment of the invention, the specific value VSₘₐᵣₖₑᵣₛ is different for each marker M of the mixture R1. In another embodiment of the invention, the specific value VSₘₐᵣₖₑᵣₛ is the same for at least two markers of the mixture R1. Advantageously, when the detection means is a mass spectrometer, the physical quantity measured is the mass/charge ratio (m/z). In an embodiment, recording of the elution chromatogram of the markers is carried out by recording all of the spectrograms of the mass/charge ratios, i.e. for a value VSₘₐᵣₖₑᵣₛ of the mass/charge ratio (m/z) that varies from 35 to 550, preferably 50 to 450.

In another embodiment, the elution chromatogram of the markers is recorded for defined mass/charge ratios, i.e. the value VSₘₐᵣₖₑᵣ is fixed for certain mass/charge ratios (m/z). In this case signals corresponding to the specific ion-fragments produced by the ionization and fragmentation of the markers M are recorded. Advantageously, when the value VSₘₐᵣₖₑᵣ is fixed, these values are selected from the following group:

TABLE I

| Family of markers | | VSₘₐᵣₖₑᵣ (m/z) |
|---|---|---|
| Saturated | n-, iso-, methyl-alkanes | 85 |
| | tri-, tetra-, penta- and hexacyclic | 191 |
| | triperpanes | |
| | regular steranes | 217 |
| | monocycloalkanes | 68 and 82 |
| | regular triperpanes demethylated | 177 |
| | in position 25 | |
| | methyl-hopanes | 205 |
| | bicyclanes | 193 |
| | bicyclanes and 8,14-secohopanes | 123 |
| | methylsteranes | 231 |
| | iso-steranes | 218 |
| | rearranged steranes | 259 |
| | gammacerane | 191 |
| | oleanane | 191 |
| | diahopanes and hopanes | 191 |
| Unsaturated | regular isoprenoid | 183 |
| Aromatics, not | benzene/toluene | 78/92 |
| sulphur-containing | | |
| | alkylbenzenes | 91, 92, 105, 106, |
| | | 119, 120, 133, |
| | | 134 |
| | naphthalene | 128 |
| | methyl, dimethyl and trimethyl | 142/156/170 |
| | naphthalene | |
| | phenanthrene | 178 |
| | methyl, dimethyl and trimethyl | 192/206/220 |
| | phenanthrene | |
| | chrysene | 228 |
| Aromatics, | benzothiophene | 134 |
| sulphur-containing | | |
| | dibenzothiophene | 184 |
| | methyl, dimethyl and trimethyl | 198/212/226 |
| | dibenzothiophene | |
| | naphthobenzothiophene | 234 |
| | methyl, dimethyl and trimethyl | 248/262/276 |
| | naphthobenzothiophene | |

The specific values VS_{probe} for the aforementioned probes are

TABLE II
Specific values VS_{probe} of probes S

| Probe | VS_{probe} (m/z) |
|---|---|
| n-alkanes comprising from 5 to 50 carbon atoms and | 66 |
| 12 to 102 deuterium atoms | |
| cholestane-d₄ | 221 |
| naphthalene-d₈ | 136 |
| dibenzothiophene-d₈ | 192 |
| phenanthrene-d₁₀ | 188 |
| chrysene-d₁₄ | 240 |

Identification of the Position of the Probes and Markers on the Chromatogram

The signals of the eluted products are examined. The probes S are identified by their unequivocal signal. The retention time of each probe S is measured on the elution chromatogram (14). The retention time of each marker M is measured on the elution chromatogram (14). The retention time of each probe S and of each marker M is recorded. This recording may be graphical and/or digital. The set of retention times of each probe S on the elution chromatogram constitutes the fingerprint E₀ (15) of the chromatogram for a given introduction at t=t₀.

In a preferred embodiment of the invention, the retention indices are calculated for each marker M and for each probe S. The retention index of a compound is the ratio of the retention time of the compound to the difference between the retention time of a first reference (probe eluted at the start of analysis) and the retention time of a second reference (probe eluted at the end of analysis). In the rest of the present application, the terms “retention time” and “retention index” may be substituted for one other.

Obtaining the Chromatogram C₀ (16)

The chromatogram C₀ (35) comprises the value of the retention time of each marker M and the fingerprint E₀ (34), i.e. the values of the retention times of each probe S, for a simultaneous introduction of the mixture R1+R2 at a time t=t₀. The chromatogram C₀ may be graphical or digital. The chromatogram C₀ (35) is recorded by information technology means that are well known to a person skilled in the art.

Repetition for One and the Same Chromatography Device

Steps b) to g) are repeated n times at different times tᵢ with i varying from 0 to n on the same chromatography device. For each time tᵢ, the fingerprint Eᵢ (15) is determined and the corresponding chromatogram Cᵢ (16), associated with the fingerprint Eᵢ, is recorded. A time tᵢ corresponds to a degree of ageing of the column over time at the instant i. The time tᵢ corresponds to a degree of ageing of the column over time.

The period of time from t₀ to tₙ represents the length of time during which the collection of chromatograms Cₙ (17) is constituted, n representing the number of simultaneous introductions of the mixture R1+R2. n is an integer greater than 0, preferably comprised between 30 and 100. Advantageously, when the sample is a crude oil, in particular a sample of a sub-fraction of this crude oil, n is in the range from 40 to 50.

The simultaneous introductions of the mixtures R1+R2 into the chromatography device may be carried out according to a specified frequency (for example weekly) or at random. Preferably, a collection of chromatograms C₀, C₁, C₂ . . . Cᵢ . . . Cₙ is constituted, regularly spread out over time. The times tᵢ with i varying from 0 to n with n>0 may cover some or all of the life of a chromatographic column. A chromatographic column is at the end of its life when its resolution is deemed insufficient and when the mobile phase is excessively degraded chemically. These criteria are well known to a person skilled in the art, who may in particular consult the Manuel pratique de chromatographie en phase gazeuse [Practical manual of gas chromatography]. Jean Tranchant, Masson Publishers, June 1995.

In this case, by “the same chromatography device” is meant that steps b) to g) are carried out without any change of column, detection means or operating conditions. Of course, the column cannot be strictly identical to the column used at the start of the method, since between each time tᵢ and tᵢ₊₁ the chromatographic device has aged and has suffered wear.

The set of chromatograms Cᵢ with i varying from 0 to n constitutes the collection of chromatograms C₀, C₁, C₂ . . . Cᵢ . . . Cₙ for a given reference mixture R1, for a mixture of probes R2 and for a given chromatography column, each chromatogram C₀, C₁, C₂ . . . Cᵢ . . . Cₙ being associated with a fingerprint E₀, E₁, E₂ . . . Eᵢ . . . Eₙ respectively. Another subject of the present invention relates to a collection of chromatograms C₀, C₁, C₂ . . . Cᵢ . . . Cₙ resulting from:

simultaneous elution, repeated at times t₀, t₁, t₂ . . . tᵢ . . . tₙ, n being an integer n>0, of a reference mixture R1 of organic compounds comprising at least two markers M and of a mixture R2 comprising at least two labelled probes S, on a chromatography column, and detection of the components of the mixture R1+R2 using at least one detection means measuring at least one physical quantity, each probe S being characterized by at least one unequivocal signal detectable at a specific value VS_{probe} of the physical quantity measured, and

recording the elution chromatogram of the markers, each chromatogram Cᵢ with 0≦i≦n comprising a fingerprint Eᵢ with 0≦i≦n corresponding to the retention times of the probes of mixture R2.

Another subject of the present invention relates to a method for the identification of at least one compound in a sample from an organic mixture, said method comprising the following steps:
(a1) providing a chromatographic device comprising at least one chromatographic column and at least one detection means measuring a physical quantity, said detection means being coupled to the chromatographic column
(b1) providing at least one collection of chromatograms of a reference mixture R1 and of a mixture R2 of probes S as defined above, using a chromatographic column and a detection means identical to those employed in step (a1)
(c1) simultaneously introducing, into the chromatographic device, the sample and the mixture R2 that is identical to the mixture R2 that was used for constituting the collection of chromatograms,
(d1) eluting the compounds of the sample and the probes S with at least one mobile phase,
(e1) recording the elution chromatogram C of the probes S and of the compounds in the sample,
(f1) identifying the retention time of each probe S of the mixture R2 on the chromatogram C obtained in step (e1) in order to obtain the fingerprint E of the sample,
(g1) comparing the fingerprint E from step (f1) with each fingerprint E₀, E₁, E₂ . . . Eᵢ . . . Eₙ of the chromatograms C₀, C₁, C₂ . . . Cᵢ . . . Cₙ of the collection of chromatograms,
(h1) identifying the chromatogram Cⱼ of which the fingerprint Eⱼ is substantially superposable on the fingerprint E from step (g1),
(i1) comparing chromatogram C with chromatogram Cⱼ.

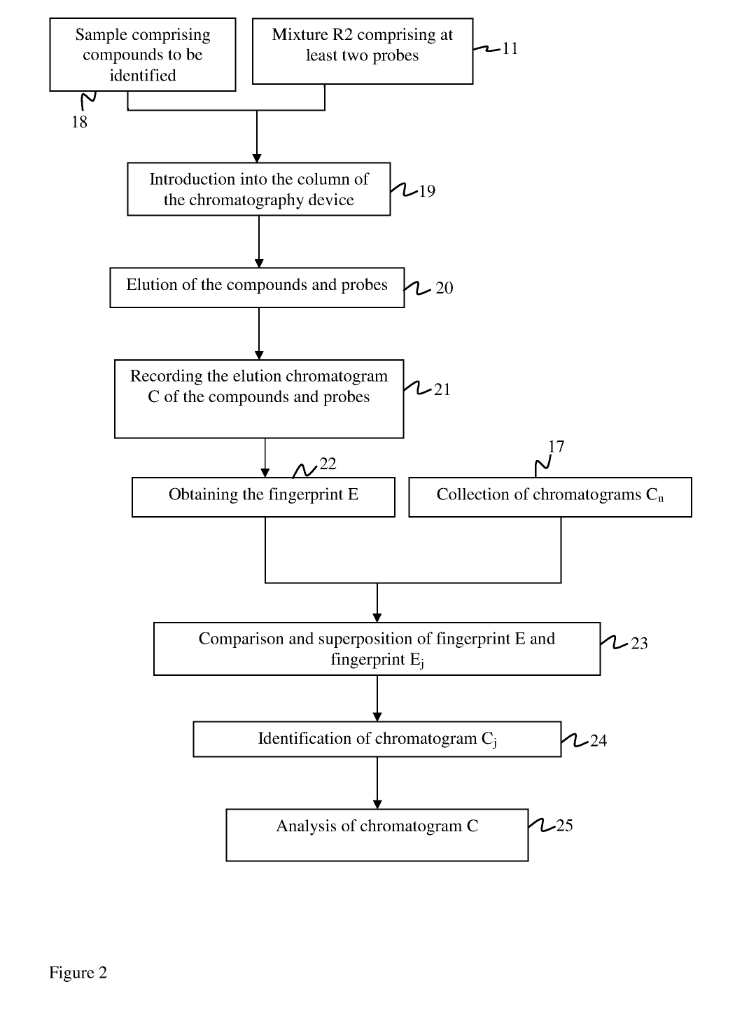

The main steps of the method for the identification of at least one compound in a sample from an organic mixture will now be presented, with reference to FIG. 2. Items that are common to both figures are denoted by the same reference.

By “identical chromatographic column and detection means” is meant, within the meaning of the present invention, a chromatographic column and a detection means constituted by the same elements arranged in the same configuration as those used in the method for constituting the collection of chromatograms as defined above. The column has the same dimensions and the same stationary phase as that used for implementing the method for constituting a collection of chromatograms defined above and the detection means is of the same nature as that used while implementing the method for constituting a collection of chromatograms as defined above. The operating conditions of the chromatographic device that was used for implementing the method for constituting a collection of chromatograms as defined above and the operating conditions of the chromatography device for implementing the method of identification according to the invention are the same, in particular the mobile phase, temperature, pressure etc. Ageing of the stationary phases is a physicochemical phenomenon that varies randomly and non-linearly. It cannot be predicted and depends on a certain number of parameters such as the nature of the stationary phase, the nature and the quantity of the compounds injected, etc.

The mixture R2 (11) used in the method of identification is identical to the mixture R2 that was used for constituting the collection of chromatograms, i.e. it consists of the same probes as those used for implementing the method for constituting a collection of chromatograms as defined above. Simultaneous introduction (19) of the sample from the mixture to be analysed (18) and of the mixture R2 (11) into the chromatography device is carried out with introduction means that are well known to a person skilled in the art, such as a syringe, an injection valve, etc. Elution (20) of the compounds of the sample from the mixture to be analysed and of the probes S is carried out under the same operating conditions and with the same mobile phase as were used for the elution step in the method for constituting a collection of chromatograms as defined above. The chromatogram C (21) is recorded, which comprises:

the chromatographic peaks of each probe and the unequivocal signal from the probe associated with each of the peaks, and

the chromatographic peaks of the compounds of the sample to be analysed and the signal or signals of these compounds associated with each of these peaks.

The peaks and the signals of the probes are recorded at at least one specific value VS_{probe} of the physical quantity measured. The peaks and the signals of the compounds of the sample to be analysed are recorded at at least two values of the physical quantity measured (VSₘₐᵣₖₑᵣₛ) of the markers of the mixture R1.

Identification of the position of each probe S on the chromatogram C is carried out in the same way as was used in the method for constituting a collection of chromatograms as defined above. Briefly, based on its unequivocal signal, the probe S is identified in the detection signals associated with each elution peak. The retention time of the probe S is identified on the chromatogram C. This operation is repeated so as to identify the position of each probe S on the chromatogram C. The set of retention times of the probes S on the chromatogram constitutes the fingerprint E (22) of chromatogram C.

Then the fingerprint E (22) of chromatogram C is compared (23) with the chromatographic fingerprints E₀, E₁, E₂ . . . Eᵢ . . . Eₙ recorded in the collection of chromatograms Cₙ (17) of the reference mixture R1. The comparison step is carried out with information technology means using software, the main steps of which are as follows:
1. Measure the retention times of all the peaks of chromatogram Cj of the sample to be analysed, from the signal or signals recorded by the detector or all of the detectors.
2. Locate the probes S of the mixture R2 and measure their retention time.
3. Calculate the difference D between the retention times xt of the probes in the sample analysed and those of the probes yt of the samples in the database (collection of fingerprints Eₙ of chromatograms Cₙ): D=Σ₁^{m}(xt−yt)², where m is the number of probes S and t is the serial number of the probe.
4. Once D has been calculated, from the database select the chromatogram Cᵢ and the associated data, for which D is minimum.
5. The retention indices of the markers M of chromatogram Cᵢ are used in order to calculate the expected retention times of the same compounds for the sample analysed.
6. The peaks of the compounds in the sample analysed are identified.

The comparison makes it possible to identify (24) a chromatogram Cⱼ (24) of which the chromatographic fingerprint Eⱼ is substantially superposable on the chromatographic fingerprint E (22). By “substantially superposable” is meant, within the meaning of the present invention, obtaining a single image when the chromatograms are superimposed. The retention time of each probe S on the chromatogram Cⱼ is then substantially identical to the retention time of the same probe on the chromatogram C. This similarity is quantified by calculating the difference D between the retention times xt of the probes S in the sample analysed and those of the probes yt of the samples in the database (collection of fingerprints Eₙ of chromatograms Cₙ): D=Σ₁^{m}(xt−yt)², where m is the number of probes S and t is the serial number of the probe. Once D has been calculated, the chromatogram Cⱼ for which D is minimum is selected in the database.

Then chromatogram C is analysed (25) by comparison with chromatogram Cⱼ and the presence of a compound is or is not identified in the sample from the mixture to be analysed. Identification of the compound or compounds of the sample from the organic mixture is carried out by comparing each peak of the chromatogram of the sample C (or each retention time) with those of chromatogram Cⱼ. The peaks of chromatogram Cⱼ that are superposable on the peaks of chromatogram C of the sample indicate the presence of markers M in the sample.

Advantageously, the invention described above is carried out for the identification of at least one compound in a sample of a crude oil, in particular at least one compound in a sample of a sub-fraction of a crude oil. Another subject of the present invention relates to a kit for implementing the method for constituting a collection of chromatograms as defined above and/or for implementing the method for the identification of at least one compound in a sample of a crude oil, said kit comprising at least:
a reference mixture R1 comprising at least two markers M selected from the group comprising saturated or unsaturated, linear or branched hydrocarbons comprising from 5 to 50 carbon atoms, cyclic hydrocarbons, in particular aromatic hydrocarbons comprising from 5 to 50 carbon atoms, steroids and mixtures thereof,
a mixture R2 comprising at least two deuterium-labelled probes S, each S being a hydrocarbon compound comprising at least 5 carbon atoms, preferably from 5 to 50 carbon atoms, said compound being saturated or unsaturated, linear, branched or cyclic, in particular aromatic, and optionally comprising at least one sulphur, oxygen or nitrogen heteroatom.

In a variant, the kit further comprises at least one chromatography column as defined above. The column is preferably a partition column. Another subject of the present invention relates to a kit for implementing a method for the identification of at least one compound in a sample from an organic mixture, said kit comprising:
a collection of chromatograms C₀, C₁, C₂ . . . Cᵢ . . . Cₙ resulting from:
   simultaneous elution, repeated at times t₀, t₁ t₂, . . . tᵢ . . . tₙ, n being an integer n>0, of a reference mixture R1 of organic compounds comprising at least two markers M and of a mixture R2 comprising at least two labelled probes S, on a chromatography column, and detection of the components of the mixture R1+R2 using at least one detection means measuring at least one physical quantity, each probe S being characterized by at least one unequivocal signal detectable at a specific value VS_{probe} the physical quantity measured, and probe of
   recording the elution chromatogram of the markers, each chromatogram C_{i with 0≦i≦n} comprising a fingerprint E_{i with 0≦i≦n} corresponding to the retention times of the probes of the mixture R2.
a chromatography column identical to that used for constituting the collection of chromatograms,
a mixture of probes R2 identical to that used for obtaining the collection of chromatograms.

The invention applies to the field of analytical chemistry. It can be utilized for the identification of several constituents of a complex organic mixture. The invention advantageously makes it possible to determine the nature, origin and alteration of a crude oil extracted from a geological formation, to determine the nature of the pollutants in an aquifer, to identify the constituents of a perfume, etc. It can also be utilized for the identification of a compound in a complex mixture, as is the case for example for toxicology investigations, and quality control in the food, pharmaceutical or cosmetic field.

### Example

Other features and advantages of the invention will become apparent on reading the following description of a preferred embodiment of the invention, given as an example and with reference to the attached figures. The method according to the invention is implemented for determining the chemical composition of a mixture of hydrocarbons extracted from a geological formation (called crude oil hereinafter) by gas chromatography coupled to a mass spectrometer. A crude oil is a complex mixture that may contain thousands of different hydrocarbons, all in variable concentrations.

A-1 Constitution of the Mixture R1:

This mixture is selected in such a way that it contains most of the known biomarkers of crude oils of different geological origin (see Table III). As the crude oils have very variable compositions (depending on their age, their degree of natural alteration, etc.), no oil contains all the known biomarkers. For example, gammacerane and oleanane, molecules formed by organisms that lived in completely different environments, are rarely encountered in the same crude oil. Moreover, certain molecules appear late in the evolution of life. All of these known biomarkers are rarely present simultaneously in one and the same crude oil. The reference mixture R1 is therefore an artificial signature that contains a set of individual signatures of crude oils.

Thus, mixture R1 is a mixture comprising at least one compound belonging to the 25-norhopanes family, at least one compound belonging to the family of the tri-, tetra-, penta- and hexacyclic terpanes, gammacerane, oleanane, at least one compound belonging to the diahopanes family, at least one compound belonging to the steranes family, at least one compound belonging to the 8,14-secohopanes family, and at least one compound belonging to the diasteranes family.

TABLE III
EXAMPLE OF TYPICAL SATURATED MARKERS (FOSSIL BIOMARKERS)
PRESENT IN CRUDE OILS, DEPENDING ON THEIR GEOGRAPHIC ORIGIN

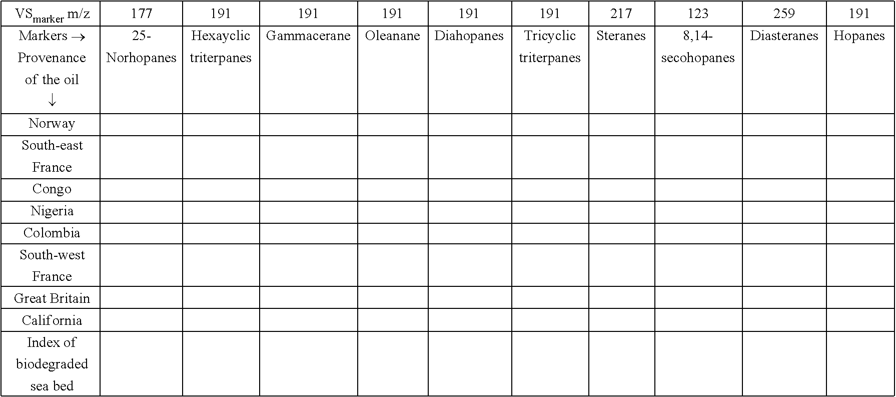

A-2 Constitution of the Mixture R2 for the Saturated Hydrocarbons

In a second step, a reference mixture R2 is constituted, which comprises 3 deuterium-labelled probes:
Probe S1: nC₂₄-d₅₀,
Probe S2: nC₃₆-d₇₄,
Probe S3: cholestane-d4
   Probes S1 and S2 are representative of the linear chain saturated hydrocarbon compounds contained in the crude oils and probe S3 is representative of the saturated cyclic hydrocarbons contained in the crude oils.

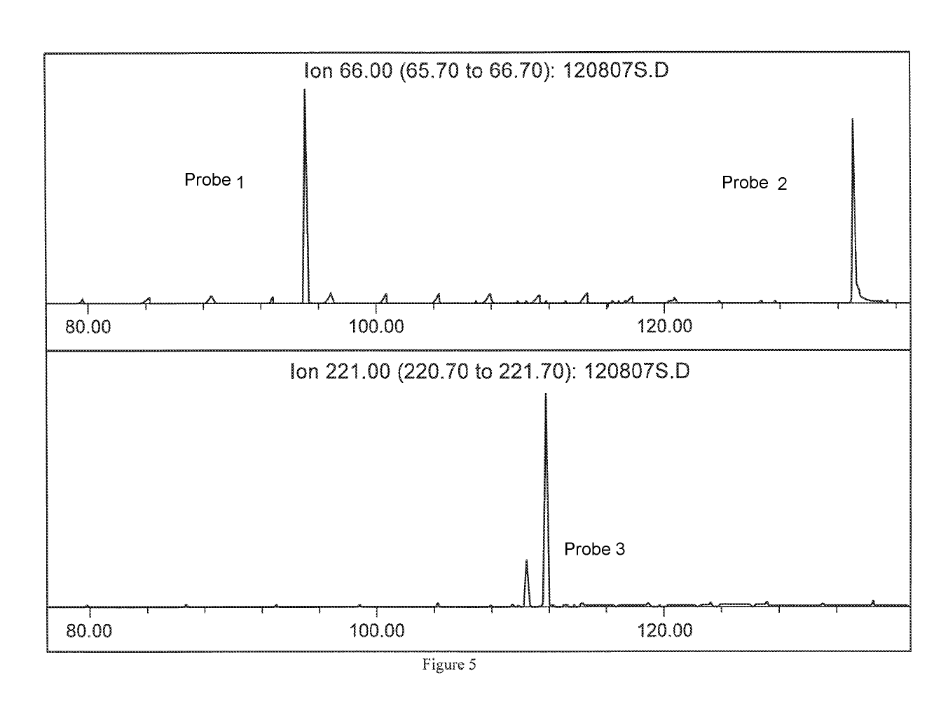

These probes are easily identifiable on the elution chromatogram by adopting a value of the mass/charge ratio (m/z) specific to each probe. In fact, each probe was selected so as to provide a single signal at a given value of the mass/charge ratio (m/z). As shown in FIG. 5, probe S1 has a single signal, easily identifiable when we adopt a value m/z=66. The same applies to probe S2. Probe S3 has a single signal, easily identifiable when we adopt a value m/z=221. Therefore the position of each probe S on the elution chromatogram is identified and the retention time of each probe S is calculated.

A-3: Chromatographic Equipment and Operating Conditions:

The apparatus used is a gas chromatograph (GC) (Agilent 7890) coupled to a single quadrupole mass spectrometer (MS) (Agilent 5975 C). The software for data acquisition and preliminary processing is an Agilent Chemstation. The chromatographic column is a capillary column, 60 meters long and with an internal diameter of 0.25 mm and a nonpolar phase with a thickness of 0.1 μm. At a time t=t₀, the reference mixture R1 and the mixture R2, containing the three probes S1, S2 and S3, are injected simultaneously into the chromatographic device described above.

The operating conditions are summarized in Table IV below.

TABLE IV
OPERATING CONDITIONS

| | |
|---|---|
| Mobile phase | helium |
| Flow rate of the mobile phase | 2 ml/min |
| Injector temperature | 50° C. (“on column” injector) |
| Column temperature | 50 to 350° C., 2° C./min |
| Type of column | Nonpolar (OV-1, |
| | polydimethylsiloxane) |
| Volume of sample injected | 1 microlitre diluted |
| Analysis time | 3.5 hours |
| Detector | Agilent 5975 C mass spectrometer |
| GC/MS interface | 350 degrees |

A-4 Constitution of a Collection of Chromatograms:

The elution chromatogram of the mixture R1+R2 is recorded by recording the signals of the 3 probes at values VS_{probe} equal to m/z 66 and m/z 221 and by recording the signals of the biomarkers at values VSₘₐᵣₖₑᵣₛ equal to m/z 123, m/z 177, m/z 191, m/z 217, m/z 259. The position of each probe Son the elution chromatogram is identified by examining the mass spectrogram recorded at a value of the mass/charge ratio (m/z) equal to 66 and of that recorded at a value of the mass/charge ratio (m/z) equal to 221. The retention time of each probe S is calculated and the fingerprint E₀ is obtained.

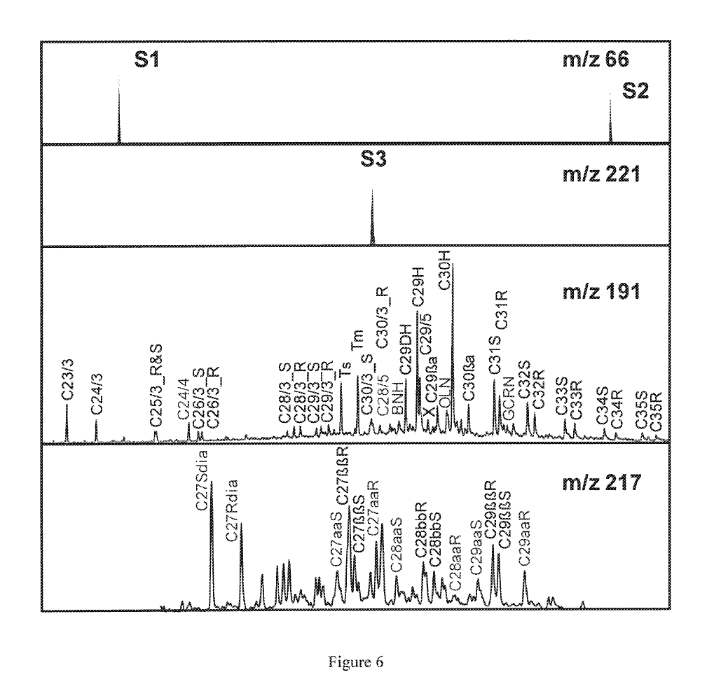

FIG. 6 illustrates the elution chromatogram of the markers recorded at a value of the mass/charge ratio (m/z) equal to 191 and that recorded at a value of the mass/charge ratio (m/z) equal to 217. Then the retention time of each biomarker is measured on its characteristic mass spectrogram. Thus, for the markers belonging to the terpanes family, the retention time of each marker is calculated from the elution chromatogram recorded at a value of the mass/charge ratio (m/z) equal to 191. For the markers belonging to the steranes family, the retention time of each marker is calculated from the elution chromatogram recorded at a value of the mass/charge ratio (m/z) equal to 217.

A chromatogram C₀ is thus obtained comprising the identified position of the three probes S and the biomarkers of the terpanes family and of the steranes family. The position of the three probes at time t=t₀ forms the fingerprint E₀ of chromatogram C₀.

Simultaneous introduction of the mixture (R1+R2) is repeated one week (t₁) after the first introduction of the mixture (t₀) and under the same operating conditions as those described in Table IV and the signals of the probes and biomarkers are recorded as before. The chromatogram C₁ and its fingerprint E₁ are established, as described above for chromatogram C₀; i.e. by identifying the position of the probes S1, S2 and S3 by examining the mass spectrogram recorded at a value of the mass/charge ratio (m/z) equal to 66 and of that recorded at a value of the mass/charge ratio (m/z) equal to 221 in order to obtain the fingerprint E1. The position of the biomarkers of the terpanes family and steranes family is identified by examining the mass chromatogram recorded at a value of the mass/charge ratio (m/z) equal to 191 and of that recorded at mass/charge ratio (m/z) equal to 217 respectively.

Introduction of the mixture (R1 and R2) is repeated at least about forty times and at a weekly frequency, each introduction being carried out under the same operating conditions as those described in Table IV. For each introduction, a chromatogram Cᵢ is obtained comprising the fingerprint Eᵢ and the position of each biomarker for time t=tᵢ. Now, with ageing of the column, drift of the retention times and of the retention indices of probes S1, S2 and S3 and of the biomarkers is observed, relative to those observed for t=t₀. Thus, a collection of elution chromatograms of the biomarkers is obtained, each chromatogram Cₙ being representative of a stage of ageing of the stationary phase of the column.

A-5 Analysis of a Sample:

Analysis of the compounds in the sample of crude oil is then carried out. The sample of crude oil and the mixture R2 comprising the 3 deuterium-labelled probes:

Probe S1: nC₂₄-d₅₀,

Probe S2: nC₃₆-d₇₄,

Probe S3: cholestane-d4

are injected simultaneously into the chromatographic device that was used for establishing the chromatograms of the reference mixture R1. The sample of crude oil may optionally undergo a step of preparation before mixing it with the mixture R2 and introducing it into the chromatography column.

The elution chromatogram (chromatogram C) of the mixture of the sample of crude oil and of the probes is recorded by recording the signals of the 3 probes at a value VS_{probe} equal to m/z 66 and m/z 221 and by recording the signals of the compounds in the sample of the crude oil at values VSₘₐᵣₖₑᵣₛ typically equal to m/z 85, m/z 183, m/z 123, m/z 177, m/z 191, m/z 205, m/z 217, m/z 218, m/z 231, m/z 259. The probes S1 and S2 are identified from their single signals observable on the mass spectrogram recorded at a value of the mass/charge ratio (m/z) equal to 66. The position of the probe S3 is identified from its single signal observable on the mass spectrogram recorded at a value of the mass/charge ratio (m/z) equal to 221.

The retention time of each probe is measured on its specific mass spectrogram. These retention times of the three probes make it possible to define the fingerprint E of the sample of crude oil. The latter is compared, by information technology means, with the fingerprints Eₙ of the chromatograms Cₙ recorded in the collection of chromatograms of the reference mixture R1.

The chromatogram Cⱼ is identified for which the retention times of the 3 probes of the fingerprint Eⱼ of time tⱼ are substantially identical to the three retention times of fingerprint E. Thus, the chromatogram Cⱼ that corresponds to a stage of ageing tⱼ of the column is identified: the chromatogram Cⱼ provides the retention times of the markers belonging to the terpanes family and stearanes family, allowing precise calculation of the expected location of the peaks of these compounds on the chromatogram C of the crude oil to be analysed. The geographic origin of the crude oil is determined as a function of the presence or absence of certain markers.

These results were obtained regardless of the degree of ageing of the column and without any need to carry out regular calibrations of the chromatography column. The invention saves a considerable amount of time and is more reliable than the existing techniques for the identification of a crude oil.

1-15. (canceled)

16. A method for constituting a collection of chromatograms for a reference mixture R1 of organic compounds comprising at least two markers and for at least one chromatographic device comprising at least one chromatographic column and at least one detector measuring a physical quantity, the method comprising the following steps:
(a) constituting a mixture R2 comprising at least two probes, each probe sending an unequivocal signal detectable at a specific value of the physical quantity measured;
(b) at a time, simultaneously introducing the mixtures R1 and R2 into the chromatography column coupled to the detector;
(c) eluting the markers and the probes with at least one mobile phase;
(d) recording the elution chromatogram of the mixture R1 and R2;
(e) identifying a retention time of each of the probes on the chromatogram from step d) so as to obtain a fingerprint;
(f) identifying the retention time of each of the markers on the elution chromatogram from step d);
(g) obtaining the chromatogram associated with the fingerprint; and
(h) repeating steps b) to g) at regular intervals during a lifetime of the column so as to constitute a collection of chromatograms associated with a fingerprint for each time with the intervals varying from 0 to n, n being an integer n>0.

17. The method according to claim 16, wherein the probe is a probe labelled with at least one marker group selected from the group formed by a chromophore that absorbs in the ultraviolet, a chromophore that absorbs in the infrared, a phosphor or a stable isotope.

18. The method according to claim 16, wherein the chromatography column is selected from the group formed by an adsorption column, a partition column, an affinity column, an ion exchange column or a size exclusion column.

19. The method according to claim 16 wherein the physical quantity measured is selected from a wavelength, a mass/charge ratio m/z, an intensity, a strain, a chemical shift.

20. Method according to claim 19, wherein the physical quantity measured is a mass/charge ratio m/z and the detector is a mass spectrometer.

21. Method according to claim 20, wherein the recording of the chromatogram in step (d) is carried out by recording all of the spectrograms of the mass/charge ratios or by recording certain spectrograms at defined mass/charge ratios.

22. A collection of chromatograms C₀, C₁, C₂ . . . Cᵢ . . . Cₙ resulting from:
simultaneous elution, repeated at times t₀, t₁, t₂ . . . tᵢ . . . tₙ, n being an integer n>0, of a reference mixture R1 of organic compounds comprising at least two markers and of a mixture R2 comprising at least two labelled probes, on a chromatography column, and detection of the components of the mixture R1+R2 using at least one detector measuring at least one physical quantity, each of the probes comprising at least one unequivocal signal detectable at a specific value of the physical quantity measured; and
recording the elution chromatogram of the markers, each chromatogram C_{i with 0≦i≦n} comprising a fingerprint E_{i with 0≦i≦n} corresponding to the retention times of the probes of the mixture R2.

23. A method for identifying at least one compound in a sample from an organic mixture, the method comprising:
(a1) providing a chromatographic device comprising at least one chromatographic column and at least one detection means measuring a physical quantity, said detection means being coupled to the chromatographic column;
(b1) providing at least one collection of chromatograms of a first reference mixture and of a second mixture of probes, using a chromatographic column and a detection means identical to those utilized in step (a1);
(c1) simultaneously introducing, into the chromatographic device, the sample and the second mixture that is identical to the second mixture that was used for constituting the collection of chromatograms;
(d1) eluting the compounds of the sample and the probes with at least one mobile phase;
(e1) recording the elution chromatogram of the probes and of the compounds in the sample;
(f1) identifying the retention time of each probe of the second mixture on the chromatogram obtained in step (e1) in order to obtain a fingerprint of the sample;
(g1) comparing the fingerprint from step (f1) with each fingerprint of the chromatograms of the collection of chromatograms;
(h1) identifying the chromatogram of which the fingerprint is substantially superposable on the fingerprint from step (g1); and
(i1) comparing the chromatogram of step (e1) with the chromatogram of step (h1).

24. The method according to claim 23, wherein the organic mixture is a crude oil.

25. The method according to claim 23, wherein the first reference mixture comprises at least two markers selected from the group formed by saturated or unsaturated, linear or branched hydrocarbons comprising from 5 to 50 carbon atoms, cyclic hydrocarbons, comprising from 5 to 50 carbon atoms and mixtures thereof.

26. The method according to claim 23, wherein the second mixture comprises at least two deuterium-labelled probes, each probe being a hydrocarbon compound comprising at least 5 carbon atoms, said compound being saturated or unsaturated, linear, branched or cyclic, and optionally comprising at least one sulphur, oxygen or nitrogen heteroatom.

27. The method according to claim 23, wherein steps (g1) and (i1) are carried out using information technology means.

28. A kit for implementing the method according to claim 1, comprising:
a reference mixture R1 comprising at least two markers selected from the group formed by saturated or unsaturated, linear or branched hydrocarbons comprising from 5 to 50 carbon atoms, cyclic hydrocarbons comprising from 5 to 50 carbon atoms, steroids and mixtures thereof; and
a mixture R2 comprising at least two deuterium-labelled probes, each being a hydrocarbon compound comprising at least 5 carbon atoms, said compound being saturated, unsaturated, linear, branched, and/or cyclic, and optionally comprising at least one sulphur, oxygen or nitrogen heteroatom.

29. The kit according to claim 28 further comprising a chromatography column.

30. A kit for implementing the method according to claim 23, the kit comprising:
a collection of the chromatograms;
a chromatography column identical to that used for constituting the collection of the chromatograms;
a mixture of probes identical to that used for obtaining the collection of chromatograms.

31. The method according to claim 18, wherein the chromatography column is a partition column.

32. The method according to claim 25, wherein at least two markers are aromatic hydrocarbons comprising from 5 to 50 carbon atoms.

33. The method according to claim 26, wherein each of the probes is a hydrocarbon compound comprises from 5 to 50 carbon atoms.

34. The method according to claim 26, wherein each of the probes is an aromatic hydrocarbon compound.
